(19) United States
(12) Patent Application Publication
(10) Pub. No.: US 2007/0103332 A1
(43) Pub. Date: May 10, 2007

(54) IPOD 2-in-1 component - remote control and recording device

(76) Inventor: Pei Su Hong, Tainan City (TW)

Correspondence Address: Pei Su Hong, No. 2, Alley 492, Hai Tien Rd. Sec 2, Tainan City, TW

(21) Appl. No.: 11/267,635

(22) Filed: Nov. 7, 2005

(51) Int. Cl. G08C 19/00

(52) U.S. Cl. 340/825.69; 340/825.25; 381/105

(57) ABSTRACT

This invention relates to an innovated 2-in-1 unit that can add features like remote controlling and recording to IPOD without having to purchase these peripheral products separately. The major components are the multi-button high frequency transmitter that releases electrical frequency and the receiver that receives the frequency in order to perform both the remote controlling and recording functions. The whole unit comprises of a multi-button high frequency transmitter and a receiver that includes an antenna, a microphone, high frequency receiving wire, volume amplifier, micro-processing chip, IPOD headphone/data plug, and a headphone socket. With these components assembled together, the IPOD users can perform remote controlling, songs/data selection, and volume controlling all in one innovated unit.

### BACKGROUND OF THE INVENTION

Prior peripheral products on the market for IPOD such as the remote controlling and recording device are all individually produced, meaning, if users want to add more features for their IPOD unit, they would have to buy these peripheral products separately. This inconsideration of shopping manner for IPOD products, not only costs more unnecessary expenses, but also makes carrying and using inconvenience for users.

The innovated unit for IPOD fixes the above-mentioned problem. This invention employs both hardware and transmittal device, which then commutes both remote controlling and recording features in one unit. In addition, the unit puts features such as recording, remote selection, and volume control etc. all together in its menu, which provides users a more convenient and cost-efficient solution to using peripheral products for IPOD.

### SUMMARY OF THE INVENTION

A 2-in-1 innovated unit for IPOD that incorporates both remote controlling and recording features together. The major components are the multi-button high frequency transmitter and the receiver. On the receiver, there are antenna, microphone, and a standard 3.5 mm headphone socket. Also, inside the multi-button high frequency transmitter and the receiver including both hardware and transmittal device, which allows IPOD to have features like recording, remote selection, and volume control etc.

### BRIEF DESCRIPTION OF THE DRAWINGS

The designated drawing for this innovated unit is shown in FIG. 1 and FIG. 2, and the components are as the following:

Antenna

Microphone

High Frequency Receiving Wire

Volume Amplifier

Micro-processing Chip

IPOD headphone/Data Plug

Headphone Socket

Multi-button High Frequency Transmitter

Receiver

IPOD Main Unit

FIG. 1 shows the function flow chart.

FIG. 2 shows the practical applying chart.

### DETAILED DESCRIPTION OF THE INVENTION

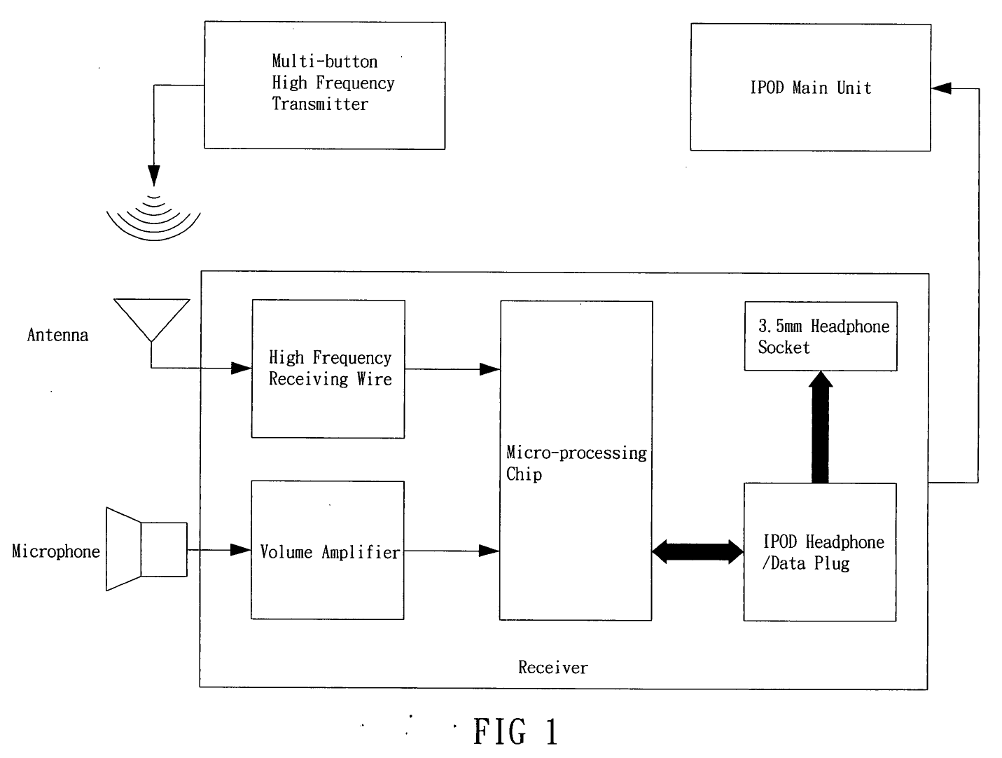

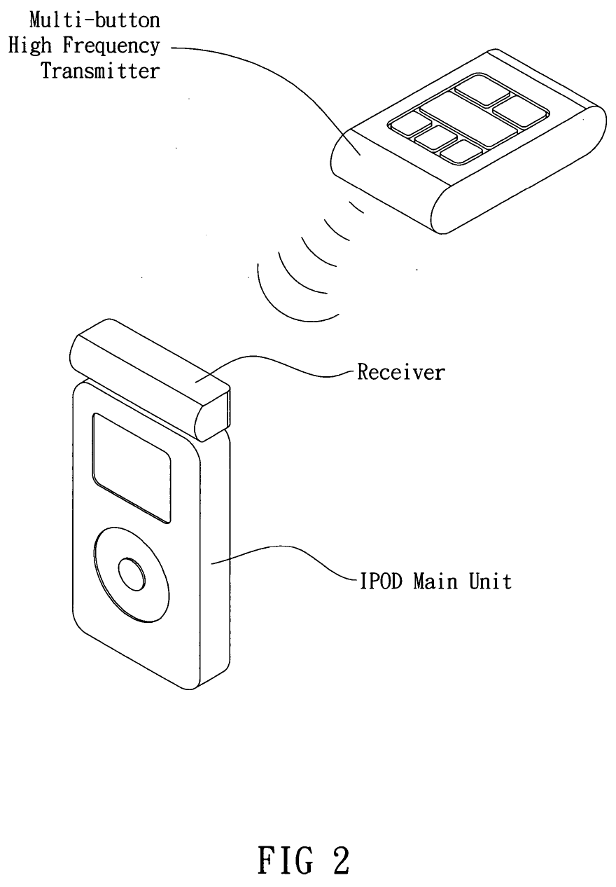

Referring to FIG. 1 and FIG. 2, this invention is mainly the collaboration of a multi-button high frequency transmitter and a receiver. The receiver comprises of antenna, microphone, high frequency receiving wire, volume amplifier, micro-processing chip, IPOD headphone/data plug, and a headphone socket. When the receiver is set together with the IPOD main unit, it receives the electrical frequency from the multi-button high frequency transmitter, through the antenna and high frequency receiving wire, and then goes to the micro-processing chip in order to proceed the remote control function. Once the receiver receives the frequency from the transmitter, with this function, users can remotely control the volume and to select songs or data. Moreover, users can perform the recording function by using the microphone preinstalled on the receiver. When users turn on the recording features, the receiver again receives the frequency from the transmitter, of which expands the voice trait through the volume amplifier, and then goes to the micro-processing chip to perform the recording function. Thus, the two major features, remote controlling and recording coordinately performed on the IPOD without having to purchase these peripheral products separately.

1. A 2-in-1 unit that has both the remote controlling and recording features for IPOD.
It is the collaboration of a multi-button high frequency transmitter and a receiver, in which the receiver comprises of antenna, microphone, high frequency receiving wire, volume amplifier, micro-processing chip, IPOD headphone/data plug, and a headphone socket. When the receiver is installed with the IPOD main unit and receives the frequency from the multi-button high frequency transmitter, users can then remotely control the volume and to select songs on IPOD, and to record songs or voices by using the microphone preinstalled on the unit.
